(19) United States
(12) Patent Application Publication
(10) Pub. No.: US 2014/0301693 A1
(43) Pub. Date: Oct. 9, 2014

(54) Optical Modulator Using Waveguides

(71) Applicant: Korea Advanced Institute of Science and Technology, Daejeon (KR)

(72) Inventors: Hyo-Hoon Park, Gangwon-do (KR); Jong Hun Kim, Daejeon (KR); Young-Tak Han, Daejeon (KR)

(73) Assignee: Korea Advanced Institute of Science and Technology, Daejeon (KR)

(21) Appl. No.: 14/357,201

(22) PCT Filed: Oct. 22, 2012
(86) PCT No.: PCT/KR2012/008664

§ 371 Date: May 8, 2014

(30) Foreign Application Priority Data
Nov. 11, 2011 (KR) 10-2011-0117703
Sep. 17, 2012 (KR) 10-2012-0102956

(51) Int. Cl. G02F 1/01; G02F 1/19

(52) U.S. Cl. CPC G02F 1/011; G02F 1/19
USPC 385/1

(57) ABSTRACT

In accordance with an optical modulator using waveguides of the present invention, the reflection phenomenon of light is used, so that the optical modulator is neither sensitive to the wavelength, mode, polarization, intensity, beam size, etc. of light, nor sensitive to the temperature, the waveguide size, the uniformity of a refractive index, carrier doping concentration, changes in control voltage/current, etc., thus obtaining stable optical modulation characteristics. An optical modulator using waveguides includes a first waveguide (11) configured to allow an optical signal to be incident thereon, and formed in a direction identical to that of the incident optical signal. A second waveguide (12) is formed to branch from the first waveguide in a first direction. A reflector (13) is arranged in a region in which the second waveguide branches from the first waveguide. A controller (14) is configured to control a refractive index of the reflector.

### TECHNICAL FIELD

The present invention relates, in general, to an optical modulator using waveguides and, more particularly, to an optical modulator that is capable of modulating optical signals passing through a main waveguide and a branch waveguide using a change in the refractive index of a reflector.

### BACKGROUND ART

In a light switching structure disclosed in Korean Patent Application Publication No. 10-2010-0066834 (hereinafter referred to as a “prior invention”), a structure for switching the path of an optical signal by controlling reflection at a small angle is proposed. However, in the “prior invention”, already modulated signal is input as incident light, but a switching structure for input incident light having a continuous waveform with continuous intensity is not yet disclosed.

Further, the “prior invention” discloses technology that uses both a waveguide on which light traveling straight from a reflector is incident and a waveguide on which light reflected by the reflector is incident, as signal lines.

A generally known optical modulator uses a Mach-Zehnder interferometer structure or a ring-resonator structure. Since these two structures use interference caused by a phase difference between light waves, they are sensitive to the wavelength, mode, polarization, intensity, beam size, etc. of light that can influence a phase, and are also sensitive to the temperature, the waveguide size, the uniformity of a refractive index, a carrier doping state, changes in control voltage/current, etc. The sensitivity of such an optical modulator that uses the phase causes a serious problem in securing the stability of performance when the optical modulator is manufactured using silicon photonics (Si-photonics).

### DISCLOSURE OF INVENTION

### Technical Problem

Accordingly, the present invention has been made keeping in mind the above problems occurring in the prior art, and an object of the present invention is to provide an optical modulator using waveguides, which uses a reflection phenomenon, so that the optical modulator is neither sensitive to the wavelength, mode, polarization, intensity, beam size, etc. of light, nor sensitive to the temperature, the waveguide size, the uniformity of a refractive index, carrier doping concentration, changes in control voltage/current, etc., thus obtaining stable optical modulation characteristics.

Another object of the present invention is to provide an optical modulator using waveguides, which is insensitive to a phase and is thus capable of utilizing a light source having a mixed wavelength of various wavelengths, such as a light-emitting diode or a lamp, unlike an existing optical modulator using a phase which requires laser light having a coherent phase as a light source (incident light).

A further object of the present invention is to provide an optical modulator using waveguides, which enables elements to be easily manufactured because the structure of the optical modulator is simplified and control conditions for a refractive index are not strict.

### Solution to Problem

An optical modulator using waveguides according to a preferred embodiment of the present invention includes a first waveguide configured to allow an optical signal to be incident thereon, and formed in a direction identical to that of the incident optical signal; a second waveguide formed to branch from the first waveguide in a first (an incident) direction; a reflector arranged in a region in which the second waveguide branches from the first waveguide; and a controller configured to control a refractive index of the reflector. In detail, the optical modulator is characterized in that one of the first waveguide and the second waveguide is used as a transmission line for the incident optical signal, and a remaining one of the first waveguide and the second waveguide is used as an extraction line for the incident optical signal.

Preferably, in the optical modulator, the controller changes the refractive index of the reflector by controlling the refractive index of the reflector, so that intensity of the optical signal reflected to the second waveguide is adjusted, thus enabling the optical signal transmitted to the first waveguide or to the second waveguide to be modulated.

Furthermore, the waveguide used as the extraction line for the optical signal has termination formed in a shape corresponding to any one of a cut shape; a ring shape or a bent shape; a shape in which a light absorber is formed; and a shape of an inclined mirror surface or a diffraction grating.

In detail, the optical signal entered into the waveguide used as the extraction line for the optical signal may be extinguished due to scattering of light by the cut-shaped end (termination) of the waveguide. Further, the optical signal incident on the waveguide used as the extraction line for the optical signal may be extinguished due to scattering and attenuation by the ring-shaped or bent-shaped termination of the waveguide.

Furthermore, the optical signal incident on the waveguide used as the extraction line for the optical signal may be absorbed and extinguished by the termination of the waveguide with the light absorber at the end of the waveguide. Furthermore, a direction of the optical signal incident on the waveguide used as the extraction line for the optical signal may be changed and the optical signal may be extracted to outside of the optical modulator, by the termination of the waveguide with the inclined mirror surface or the diffraction grating at the end of the waveguide.

### Advantageous Effects of Invention

In accordance with the optical modulator using waveguides according to preferred embodiments of the present invention, the reflection phenomenon of light is used, so that the optical modulator is neither sensitive to the wavelength, mode, polarization, intensity, beam size, etc. of light, nor sensitive to the temperature, the waveguide size, the uniformity of a refractive index, carrier doping concentration, changes in control voltage/current, etc., thus obtaining stable optical modulation characteristics.

Further, in accordance with the optical modulator using waveguides according to the present invention, the optical modulator is insensitive to a phase and is thus capable of utilizing a light source having a mixed wavelength of various wavelengths, such as a light-emitting diode or a lamp, unlike an existing optical modulator using a phase which requires laser light having a coherent phase as a light source. Furthermore, in accordance with the optical modulator using waveguides according to the present invention, the optical modulator enables elements to be easily manufactured because the structure of the optical modulator is simplified and control conditions for a refractive index are not strict.

### BRIEF DESCRIPTION OF DRAWINGS

FIG. 1 is a diagram showing a total reflection condition;

FIG. 2 is a diagram illustrating an optical modulator using waveguides according to a preferred embodiment of the present invention;

FIG. 3 is a diagram illustrating an optical modulator in which the waveguide used as an extraction line for an optical signal is terminated with a cut-shaped end;

FIG. 4 is a diagram illustrating an optical modulator in which the waveguide used as an extraction line for an optical signal is terminated with a ring-shaped end;

FIG. 5 is a diagram illustrating an optical modulator in which the waveguide used as an extraction line for an optical signal is terminated with a light absorber; and

FIGS. 6A and 6B are diagrams illustrating an optical modulator in which the waveguide used as an extraction line for an optical signal is terminated with an inclined mirror surface or a diffraction grating.

### MODE FOR THE INVENTION

Hereinafter, an optical modulator using waveguides according to embodiments of the present invention will be described in detail with reference to the attached drawings.

The following embodiments of the present invention are merely intended to embody the present invention, and are not intended to restrict or limit the scope of the present invention. Contents that can be easily inferred by those skilled in the art from the detailed description and embodiments of the present invention are interpreted as being included in the scope of the present invention.

The present invention relates to a structure for guiding light that is reflected at a small angle using a principle on which a critical angle is small under the condition of a small difference between refractive indices. Conventional technology does not specify such a principle and merely presents the range of an acute angle corresponding to a small angle. Further, the conventional technology limits an optical signal control means to elements that use “heat control”, but the present invention proposes a structure that is capable of accommodating not only elements using heat control, but also various types of refractive index control means, such as for voltage control, current control, and optical control, which can cause a small change in a refractive index.

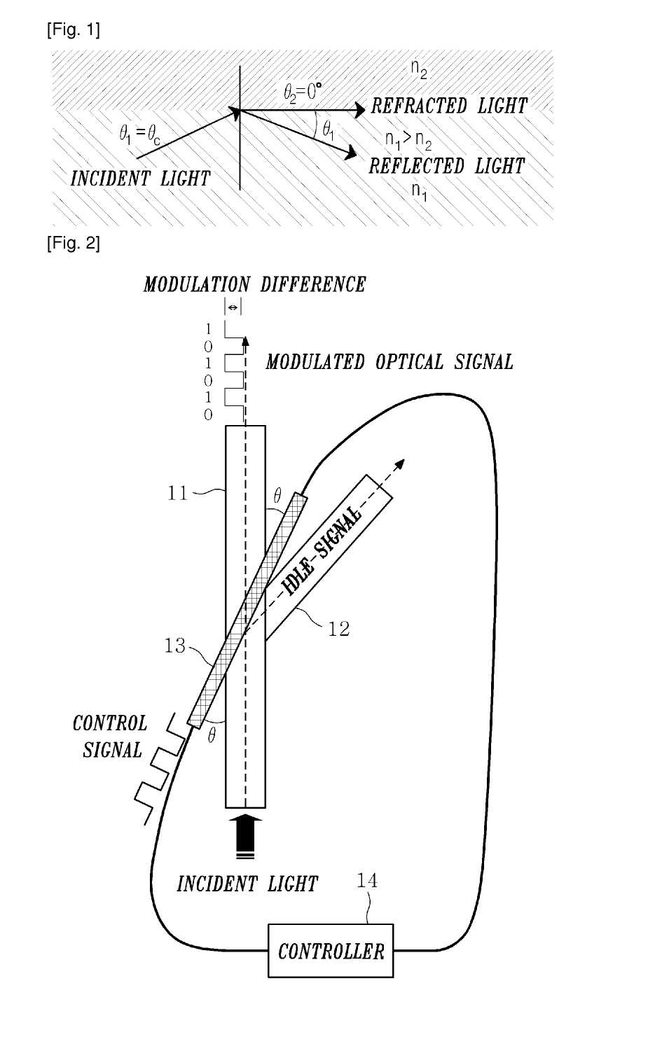

First, FIG. 1 is a diagram showing a total reflection condition.

A critical angle θ_{c} for reflection is given by θ_{c}=cos⁻(n₂/n₁), (where n₁>n₂) as shown in FIG. 1. In a material, a change in a refractive index can be obtained by various effects, such as an electro-optic effect, an electroabsorption effect, a carrier-doping effect based on plasma dispersion of electrons and holes, a thermo-optic effect, an acousto-optic effect, a nonlinear effect, and a surface plasmonic effect. However, in most materials, the change in the refractive index depending on such effects is very small such as 0.01 or less. When the refractive index change (n₁−n₂)/n₁ is very small, the critical angle is small such as several degrees (°).

For example, when a silicon semiconductor material is doped with p-type or n-type impurities, a refractive index becomes lower than that in an intrinsic state due to carriers of electrons and holes. The effect exhibits that, when the concentration of an acceptor and a donor ranges from 5×10¹⁷ to 1×10²⁰, a theoretical refractive index is lower than that of intrinsic silicon (n₁ is about 3.5) by about 5×10⁻⁴ to 1×10⁻¹. That is, a difference between the refractive indices in a doping state and an intrinsic state, that is, Δn=n₁−n₂, falls within a range from −0.0005 to −0.1, and (n₁−n₂)/n₁ falls within a range from −0.00015 to −0.03. In this range, the critical angle falls within a range from 1° to 15°, as shown in the following [Table 1]. Even in other materials, the change in the refractive index caused by an electric field or doping does not greatly exceed the above-described range of the refractive index change. Even in materials that can be generally utilized, when the range of a refractive index change that can be obtained by an electric field is taken into consideration, the critical angle is small enough to fall within the range of 20° or less. Therefore, the term “reflection at a small angle” or indicating “low angle” reflection in the present invention means reflection occurring within the range of 20° or less in which total reflection can be practically obtained by the refractive index change.

TABLE 1

| Critical angle θ_{c} | (n₁ − n₂)/n₁ |
|---|---|
| 1° | 0.00015 |
| 2° | 0.00061 |
| 3° | 0.0014 |
| 4° | 0.0024 |
| 5° | 0.0038 |
| 10° | 0.015 |
| 15° | 0.034 |
| 20° | 0.060 |

The present invention presents an optical modulator structure for modulating an optical signal using a principle on which an optical path can be changed at a small total reflection angle falling within the above-described range depending on the small refractive index change within the above-described range.

For reference, in the field of optics, the term “critical angle” is defined as an angle with respect to a vertical direction on an interface in many cases, but in the present invention, the critical angle is defined and used as an angle with respect to a horizontal direction on an interface in accordance with common-sense understanding “reflection can easily occur in case of incidence at a small angle.”

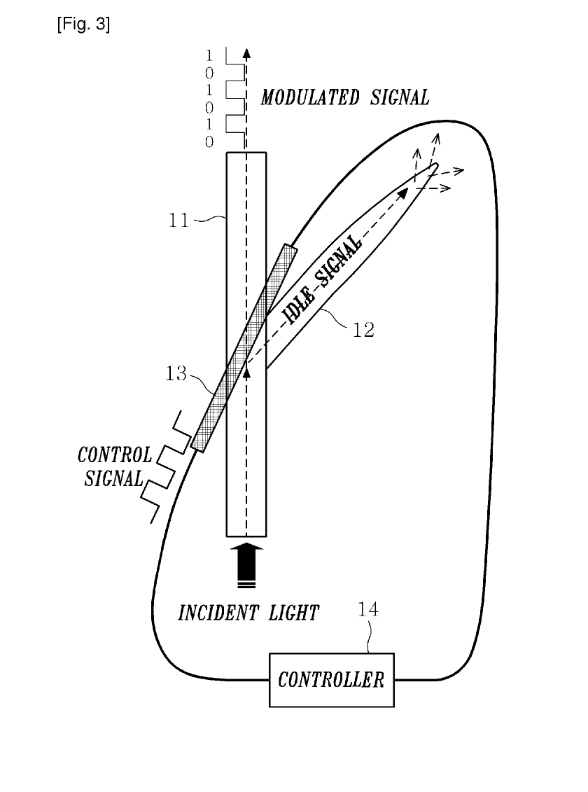

FIG. 2 illustrates an optical modulator using waveguides according to a preferred embodiment of the present invention.

As can be seen from FIG. 2, an optical modulator using waveguides according to a preferred embodiment of the present invention includes a first waveguide 11, a second waveguide 12, a reflector 13, and a controller 14.

First, the first waveguide 11 is a main waveguide, and allows an optical signal to be incident thereon, and is formed in a direction identical to that of the incident optical signal. Next, the second waveguide 12 is a branch waveguide and is formed to branch from the first waveguide 11 while forming a first angle in a first direction. The reflector 13 is arranged in a region in which the second waveguide 12 branches from the first waveguide 11, in greater detail, at a branch point (a junction) of the first waveguide 11 and the second waveguide 12. Furthermore, the controller 14 functions to generate a control signal and control the refractive index of the reflector 13. That is, a change in the refractive index of the reflector 13 is controlled by the controller 14, so that some or all of the incident optical signal is transmitted to the first waveguide 11 and the remaining optical signal other than the optical signal that has been transmitted to the first waveguide 11 is reflected to the second waveguide 12, depending on the changed refractive index.

The reflector 13 of the present invention is preferably made of a material, the refractive index of which can be changed due to the electro-optic effect, electroabsorption effect, carrier-doping effect based on plasma dispersion of electrons and holes, thermo-optic effect, acousto-optic effect, nonlinear effect, surface plasmonic effect, or the like.

The change in the refractive index of the reflector 13 based on the above-described effects is generally caused by the injection of an electric field or current (or carriers). Therefore, by way of example of this case, electrodes capable of applying an electric field or current (or carriers) may be installed near the waveguides 11 and 12, so that the reflector 13 having the function of controlling a refractive index can be configured. If the nonlinear effect or surface plasmonic effect is used, the refractive index can also be changed by light rather than electricity, so that the reflector 13 using light as a control signal can be installed. The optical modulator of the present invention generates such an electricity control signal or a light control signal in the controller 14, and transfers the control signal to the reflector 13, thus changing the refractive index of the reflector 13.

Optical modulation performed by the optical modulator using waveguides, as shown in FIG. 2, according to the preferred embodiment of the present invention can be implemented by the following mechanism.

First, incident light (an incident optical signal) having a continuous wave is input to the entrance of the first waveguide 11 that is the main waveguide. In a state in which there is no change in the refractive index and no total reflection at the reflector 13, the optical signal travels straight along the first waveguide 11. In a state in which there is enough change in the refractive index to cause total reflection at the reflector 13, the optical signal is reflected and exits through the second waveguide 12 that is the branch waveguide. Therefore, the controller 14 suitably changes the refractive index of the reflector 13 by controlling the reflector 13, thus modulating the intensity of the optical signal passing through the first waveguide 11.

An angle θ between the first waveguide 11 and the reflective surface of the reflector 13 is set to either an angle of less than a critical angle θ_{c}(θ<θ_{c}) or an angle approximate to the critical angle (θ [symbol] θ_{c}). When the angle is set to the angle of less than the critical angle, the intensity of light that is transmitted to the second waveguide 12 through total reflection can be maximized, and the modulation width (modulation difference) of the optical signal of the first waveguide 11 can be maximized.

When the angle θ between the first waveguide 11 and the reflective surface is an angle near the critical angle, which is slightly greater than the critical angle, partial light is reflected and exits through the second waveguide 12, and the remaining light passes through the first waveguide 11. In this case, a modulation width of the optical signal exiting through the second waveguide 12 can be sufficiently increased to an distinguishable range. For example, when, at the angle θ between the first waveguide 11 and the reflective surface, which is slightly greater than the critical angle, the amount of light reflected by the reflector 13 is 30%, and the remaining amount of light corresponding to 70% is input to the main waveguide, the intensity of the optical signal passing through the branch waveguide upon controlling the reflector 13 is modulated at a percentage between 30% and 0%, so that the extinction ratio of the optical signal may be 30:0. By way of this difference, the effect of modulating a digital signal or an analog signal can be sufficiently obtained. Therefore, since the optical modulation function can be achieved even at the angle θ between the first waveguide 11 and the reflective surface which is slightly greater than the critical angle, the optical modulation function can be obtained even under the condition of a very small change in a refractive index.

As described above, light passing through the first waveguide 11 can be used as a modulated optical signal or, alternatively, light passing through the branch waveguide can be used as the optical signal. One of the first waveguide 11 and the second waveguide 12, which will be used to transmit the modulated optical signal, is defined as a transmission line for the optical signal. Since the light passing through the remaining waveguide is unnecessary light as a modulated signal (idle signal), the remaining waveguide is defined as an extraction line for the optical signal.

That is, the optical modulator using waveguides according to the present invention is characterized in that one of the first waveguide 11 and the second waveguide 12 is used as a transmission line for an incident optical signal and the other of the first waveguide 11 and the second waveguide 12 is used as an extraction line for the incident optical signal. In other words, when the first waveguide 11 is used as the transmission line for the optical signal, the second waveguide 12 is used as the extraction line for the optical signal. Similarly, when the second waveguide 12 is used as the transmission line for the optical signal, the first waveguide 11 is used as the extraction line for the optical signal. Although FIGS. 2 to 6 according to the present invention illustrate examples in which the first waveguide 11 is used as the transmission line for the optical signal and the second waveguide 12 is used as the extraction line for the optical signal, the second waveguide 12 can also be used as the transmission line for the optical signal and the first waveguide 11 can also be used as the extraction line for the optical signal.

Further, the optical modulator using waveguides according to the present invention is characterized in that the intensity of an incident optical signal which is reflected to the second waveguide 12 is adjusted by controlling the refractive index of the reflector 13, thus enabling the incident optical signal to be modulated.

In accordance with a preferred embodiment of the present invention, when light passing through the extraction line for the optical signal is not used, the light needs to be extinguished for termination of light propagation near the optical modulator.

In the present invention, in order to extinguish light passing through the extraction line for the optical signal, the termination of the waveguide used as the extraction line for the optical signal can be achieved by any one of a cut shape, a ring shape, a shape in which a light absorber 15 is formed, and the shape of an inclined mirror surface 16 or a diffraction grating 17.

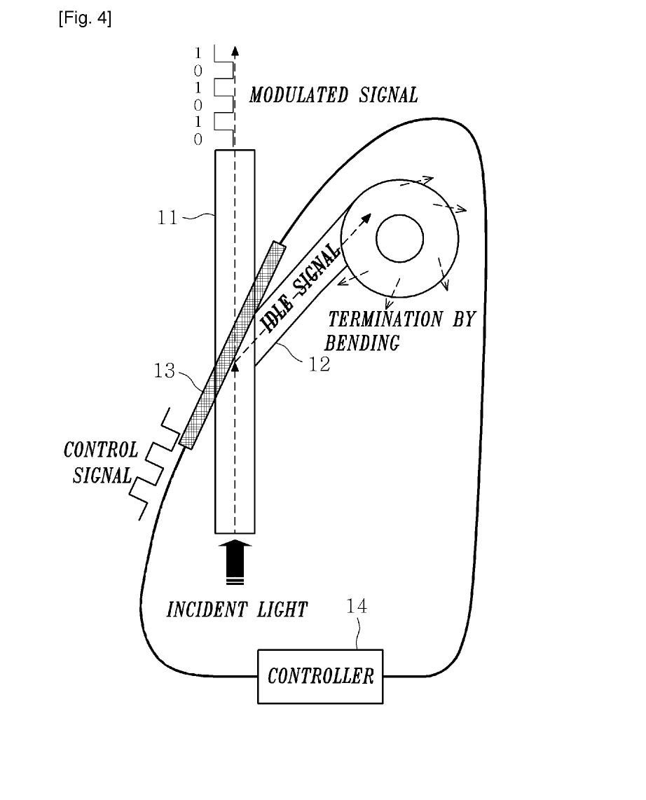

FIG. 3 is a diagram illustrating an example in which the waveguide used as an extraction line for an optical signal is terminated with cut-shaped end.

By the cut-shaped end of the waveguide used as the extraction line for the optical signal, as shown in FIG. 3, an optical signal incident on the waveguide used as the extraction line for the optical signal is extinguished due to scattering of lights.

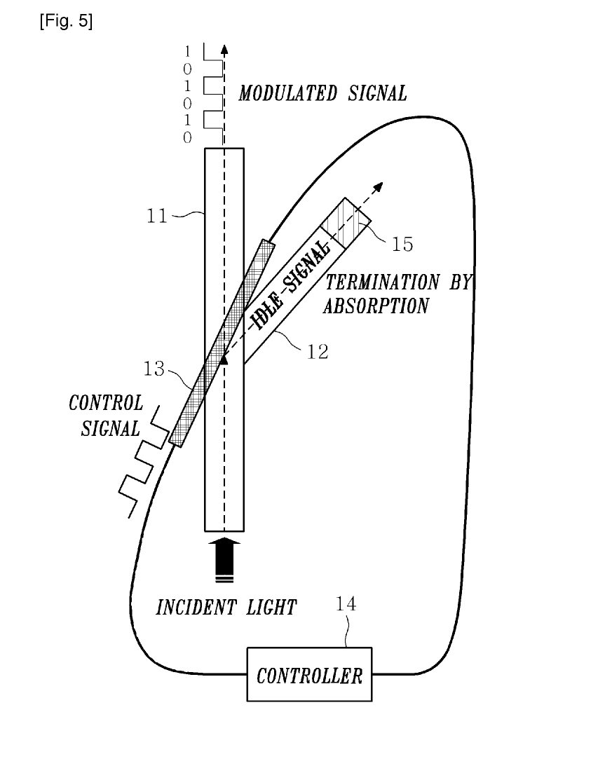

FIG. 4 is a diagram illustrating an example in which the waveguide used as an extraction line for an optical signal is terminated a ring-shaped end.

By the ring-shaped end of the waveguide used as the extraction line for the optical signal, as shown in FIG. 4, an optical signal incident on the waveguide used as the extraction line for the optical signal is extinguished due to scattering and attenuation of lights in the ring or bent waveguide.

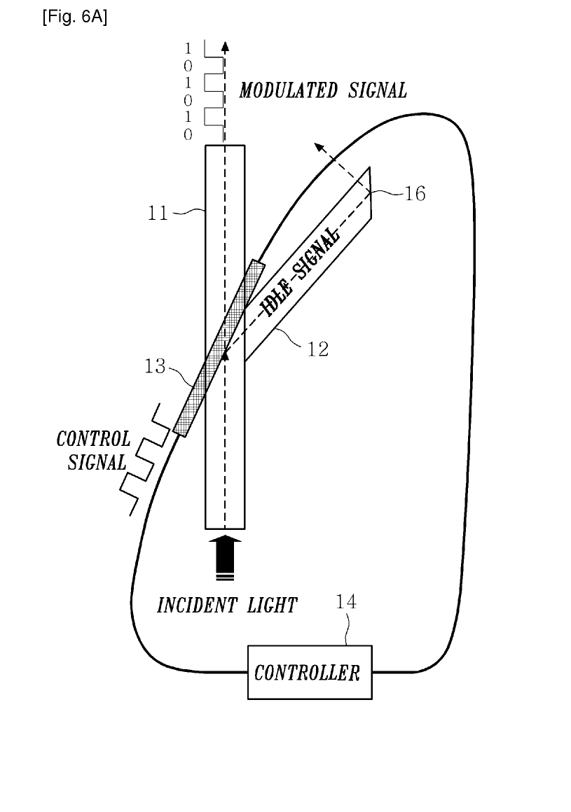

FIG. 5 is a diagram illustrating an example in which the waveguide used as an extraction line for an optical signal is terminated with a light absorber.

By the end of the waveguide at which the light absorber 15 for absorbing light is formed, as shown in FIG. 5, an optical signal incident on the waveguide used as the extraction line for the optical signal is absorbed and extinguished.

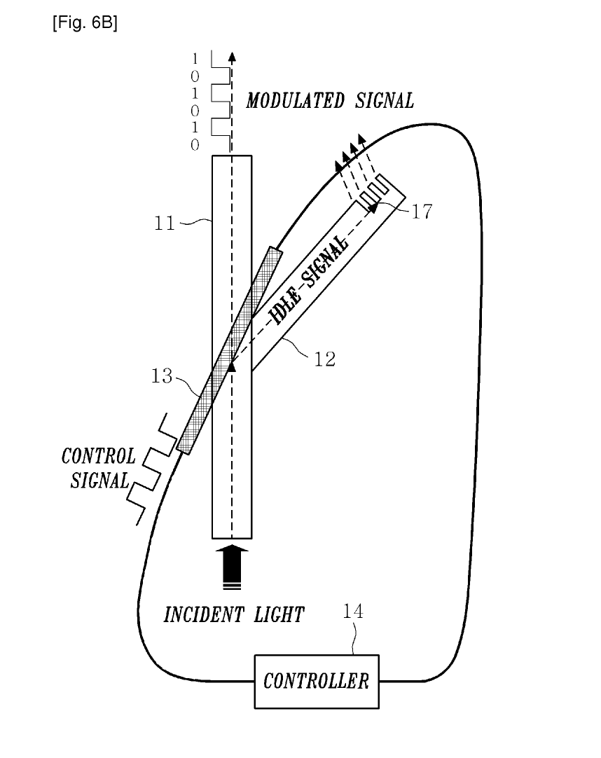

FIGS. 6A and 6B are diagrams illustrating examples in which the waveguide used as an extraction line for an optical signal is terminated with an inclined minor surface 16 and a diffraction grating 17, respectively.

By the end of the waveguide used as the extraction line for the optical signal, that is, the end having the shape of the inclined mirror surface 16 or the diffraction grating 17, the propagation direction of an optical signal incident on the waveguide used as the extraction line for the optical signal is changed to a vertical direction or a direction close to the vertical direction, so that the optical signal is extracted to the outside of the optical modulator and is then finally extinguished. In FIGS. 6A and 6B, the direction in which the optical signal is extracted to the outside is exemplified as a direction close to a right angle on the plane of the waveguide. However, it is possible to form the discharge mirror surface 16 and the diffraction grating 17 on a suitable surface, thus enabling the optical signal to be extracted to a direction close to a direction perpendicular to the waveguide plane, that is, to an approximate direction perpendicular to the surface of the substrate.

As described above, it can be seen that the optical modulator using waveguides according to the preferred embodiments of the present invention can obtain the following advantages.

(1) The reflection phenomenon of light is used, so that the optical modulator is neither sensitive to the wavelength, mode, polarization, intensity, or beam size of light, nor sensitive to the temperature, the waveguide size, the uniformity of a refractive index, carrier doping concentration, changes in control voltage/current, etc., thus obtaining stable optical modulation characteristics.

(2) The optical modulator is insensitive to a phase and is thus capable of utilizing a light source having a mixed wavelength of various wavelengths, such as a light-emitting diode or a lamp, unlike an existing optical modulator using a phase which requires laser light having a coherent phase as a light source.

(3) Elements can be easily manufactured because the structure of the optical modulator is simplified and control conditions for a refractive index are not strict.

### INDUSTRIAL APPLICABILITY

The optical modulator using waveguides according to the present invention is advantageous in that the reflection phenomenon of light is used, so that the optical modulator is neither sensitive to the wavelength, mode, polarization, intensity, beam size, etc. of light, nor sensitive to the temperature, the waveguide size, the uniformity of a refractive index, carrier doping concentration, changes in control voltage/current, etc., thus obtaining stable optical modulation characteristics.

1. An optical modulator using waveguides, comprising: a first waveguide configured to allow an optical signal to be incident thereon, and formed in a direction identical to that of the incident optical signal; a second waveguide formed to branch from the first waveguide in a first direction; a reflector arranged in a region in which the second waveguide branches from the first waveguide; and a controller configured to control a refractive index of the reflector, wherein one of the first waveguide and the second waveguide is used as a transmission line for the incident optical signal, and a remaining one of the first waveguide and the second waveguide is used as an extraction line for the incident optical signal.

2. The optical modulator of claim 1, wherein the controller changes the refractive index of the reflector by controlling the refractive index of the reflector, so that intensity of the optical signal reflected to the second waveguide is adjusted, thus enabling the optical signal to be modulated.

3. The optical modulator of claim 1, wherein the waveguide used as the extraction line for the optical signal is terminated with a shape corresponding to any one of: a cut shape; a ring shape or a bent shape; a shape in which a light absorber is formed; and a shape of an inclined mirror surface or a diffraction grating.

4. The optical modulator of claim 3, wherein the optical signal incident on the waveguide used as the extraction line for the optical signal is extinguished due to scattering of lights, by the cut-shaped end of the waveguide used as the extraction line for the optical signal.

5. The optical modulator of claim 3, wherein the optical signal incident on the waveguide used as the extraction line for the optical signal is extinguished due to scattering or attenuation of lights, by the ring-shaped or bent-shaped end of the waveguide used as the extraction line for the optical signal.

6. The optical modulator of claim 3, wherein the optical signal incident on the waveguide used as the extraction line for the optical signal is absorbed and extinguished, by the end of the waveguide at which the light absorber is formed.

7. The optical modulator of claim 3, wherein a direction of the optical signal incident on the waveguide used as the extraction line for the optical signal is changed and the optical signal is extracted to outside of the optical modulator, by the inclined mirror surface-shaped end or the diffraction grating-shaped end of the waveguide used as the extraction line for the optical signal.

8. The optical modulator of claim 2, wherein the waveguide used as the extraction line for the optical signal is terminated with a shape corresponding to any one of: a cut shape; a ring shape or a bent shape; a shape in which a light absorber is formed; and a shape of an inclined mirror surface or a diffraction grating.
